(19) United States
(12) Patent Application Publication
(10) Pub. No.: US 2010/0211988 A1
(43) Pub. Date: Aug. 19, 2010

(54) MANAGING RESOURCES TO DISPLAY MEDIA CONTENT

(75) Inventors: Bradley R. Pettit, Los Gatos, CA (US); Eric R. Soldan, Saratoga, CA (US); James A. Baldwin, Redwood City, CA (US); Nicolae Surpatanu, San Jose, CA (US); Sean K. Sharma, San Jose, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/388,172

(22) Filed: Feb. 18, 2009

(51) Int. Cl. H04N 7/173

(52) U.S. Cl. 725/134

(57) ABSTRACT

This document describes tools capable of enabling a media device to assign available resources to media content prior to receiving a request to display that media content. In one embodiment, the tools determine a next media content to be requested and available resources on a media device to display that next content. The tools may assign the available resources to the next page of media content prior to receiving a request to display the next page of media content.

### BACKGROUND

Current media devices, such as televisions, may display choppy or delayed transitions when switching between pages of media content. For example, a user that changes from channel 3 to channel 6 on a television may see a choppy or delayed transition as the television switches from displaying a current page of media content associated with channel 3 to a next page of media content associated with channel 6. Oftentimes, this choppy or delayed transition when switching between pages of media content is the direct result of the media device reassigning limited resources used by a current page of media content to the next page of media content.

Consider a case where the television in the example above has a single television tuner. This television tuner is a limited resource for displaying a page of media content associated with a channel. In other words, in order for a page of media content associated with a channel to be displayed on the television, the television tuner tunes to the correct channel. When the television switches from displaying channel 3 to displaying channel 6, the television must reassign or retune the television tuner from the channel currently being displayed (channel 3) to channel 6. Reassigning resources to pages of media content consumes time, which may cause the choppy or delayed transitions that often occur when switching between pages of media content.

Furthermore, with advances in technology, many users are now viewing pages of media content, such as television programming, using advanced media devices. Many of these advanced media devices include additional resources. For example, some television media devices now come equipped with multiple television tuners. Many media devices, however, fail to maximize the use of these additional resources.

### SUMMARY

This document describes tools capable of enabling a media device to assign available resources to media content prior to receiving a request to display that media content. In one embodiment, the tools determine a next media content to be requested and available resources on a media device to display that next content. The tools may assign the available resources to the next page of media content prior to receiving a request to display the next page of media content.

This summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in which an example embodiment of the tools may assign available resources to media content prior to receiving a request to display that media content.

FIG. 2 is a flow diagram depicting a process in an example embodiment by which the tools may act to enable a media device to assign available resources to media content prior to receiving a request to display that media content.

FIG. 3 illustrates an example media device including a resource manager and an example media device display currently displaying a first page of media content.

FIG. 4 illustrates an example media device including a resource manager and an example media device display currently displaying a second page of media content.

### DETAILED DESCRIPTION

Overview

Current media devices, such as televisions, typically display a choppy or delayed transition when switching back and forth between pages of media content.

Consider, for example, a television set-top box that connects to a television and to a television signal and turns the television signal into content, which can then be displayed on the television screen. Assume, for purposes of this discussion, that this set-top box is configured with one high definition (HD) tuner and six low resolution picture-in-picture (PIP) tuners. Consider also a “football game” application that can be implemented to display a page of media content that includes one primary football game displayed in high resolution HD and three additional football games displayed in low resolution in three PIP windows. The football game application, when played on the example set-top box, can display all four football games on a single page of media content by tuning the high definition tuner to a channel carrying the primary football game and tuning three of the six PIP tuners to the three channels carrying the three secondary football games. The HD tuner and the three PIP tuners are considered occupied tuners because they are tuned to the football game application. Notice, however, that in this example there are three PIP tuners on the set-top box that are not being used by the football game application. These three unused tuners are considered available tuners because they are not the occupied tuners being used to display the page of media content associated with the football game application. In some cases a resource may be occupied but still available, such as when the resource is capable of being used by multiple pages of media content. In the above example, however, the occupied tuners are not considered available.

Consider now a “baseball game” application that, similar to the football game application, can display a page of media content that includes one primary baseball game displayed in high resolution HD and three additional baseball games displayed in low resolution. Current set-top boxes may wait until a user watching the football game application selects the baseball game application before retuning or reassigning the HD tuner and the three PIP tuners to the baseball game application. Waiting to retune until an application change request is received, however, may cause a choppy or delayed transition as the set-top box reassigns or retunes the HD tuner and three PIP tuners from the current football game application to the requested baseball game application.

The tools described in this document enable a media device to assign available resources, such as tuners, to media content prior to receiving a request to display the media content. In one case the tools can determine a next page of media content that a user will request to display and assign available resources to the next page of media content before the next page of media content is requested by the user. For instance, in the example above, the tools may assign the three unused PIP tuners to a page of media content associated with the baseball game application prior to receiving a request to switch from the football game application to the baseball game application. Assigning available resources to a page of media content prior to receiving a request to display the page of media content may maximize the use of resources on the media device.

Furthermore, assigning available resources to a page of media content prior to receiving a request to display the page of media content eliminates or reduces the need to assign resources to the page of media content when the request is received. Eliminating or reducing the need to assign resources when the request is received reduces or eliminates the delay caused by assigning resources when the request is received, which enables an improved visual experience. For instance, in the example above, when the user requests to switch from the football game application to the baseball game application, the tools do not need to reassign the PIP tuners to the baseball game application. This may result in an improved transition between applications. Some example transitions include dissolving or fading a current page of media content into a new page of media content, such as from a page of the football game into a page of the baseball game.

In the following discussion, an example environment is first described in which the tools may enable a media device to assign available resources to media content prior to receiving a request to display the media content. An example procedure is then described that may be employed in the example environment, as well as in other environments. Although these tools are described as employed within a communication network and media device environment in the following discussion, it should be readily apparent that these tools may be incorporated within a variety of environments.

Example Environment

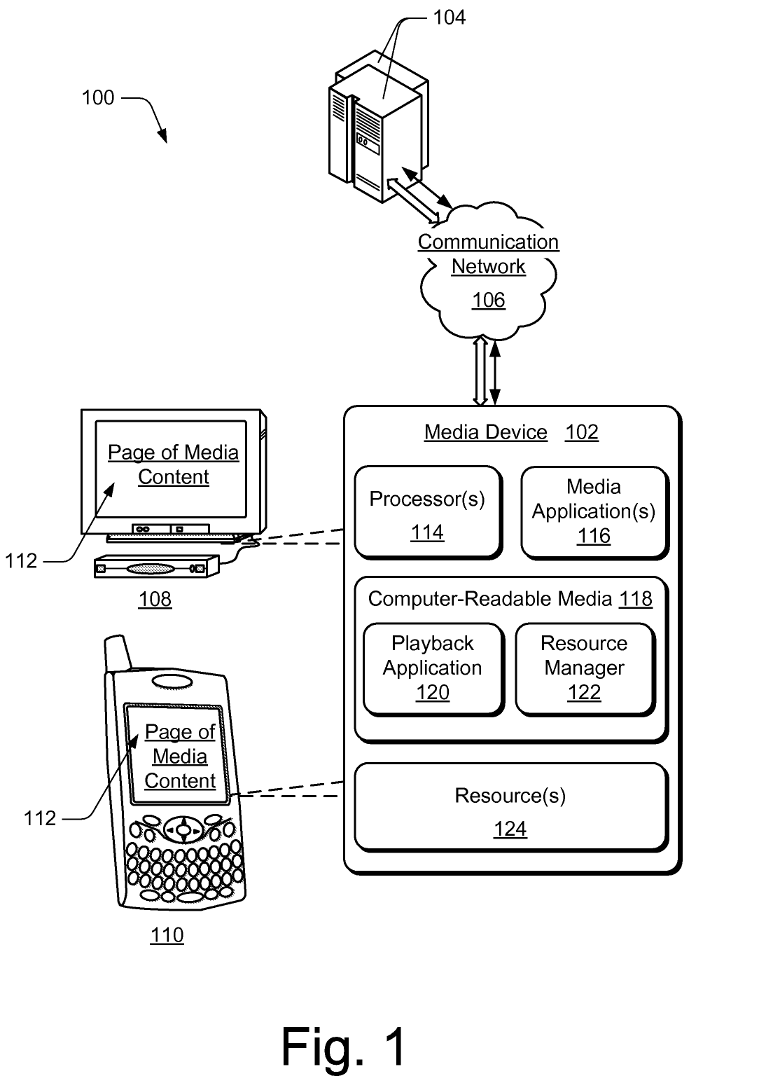

FIG. 1 is an illustration of an environment 100 in an example implementation in which the tools may operate to enable a media device to assign available or unused resources to a page of media content prior to receiving a request to display the page of media content. Environment 100 includes a media device 102 including one or more processors 114 and computer-readable media 118. The media device may also include or be communicatively coupled, through communication network 106, with one or more content distributors 104.

In the example environment 100, content distributors 104 can be implemented to communicate, or otherwise distribute, media applications and/or other data to the media device via communication network 106. For example, content distributor 104 can be implemented to distribute television programming to a television media device. Although a single communication network 106 is shown, it is to be appreciated that communication network 106 may represent network connections achieved using a single network or multiple networks. For example, communication network 106 may be representative of a broadcast network (e.g., a television broadcast network), an IP-based network, and/or a wireless network that facilitates media content distribution and data communication between the content distributors 104 and any number of the various media devices 102. The communication network 106 can also be implemented as part of a media content distribution system using any type of network topology and/or communication protocol.

Media device 102 can be configured in a variety of ways. For example, the media device may be configured as a television media device 108 (e.g., a television set-top box or a digital video recorder (DVR)), a mobile communication device 110 (e.g., cellular, VoIP, or WiFi), a portable computer device, a portable media device (e.g., mp3 player or DVD player), a computer device, a gaming system, an appliance device, an electronic device, and/or as any other type of media device that is capable of rendering one or more media applications 116.

Media applications 116 may include or receive any type of audio, video, static image, and/or image media content. This content may be internal to or from an external source, such as an animation program consuming video card and/or processor resources. Media applications may refer to those that are received from content distributors 104 (e.g., television programming received from a cable television distributor) as well as those that are stored on the media device (e.g., videos stored on a mobile communication device). Accordingly, media applications can include television programs or programming, music, movies, on-demand media content, interactive games, and any other audio, video, and/or image content.

The media application 116 may display visual media content as a page. For example, a television program media application can be viewed by a television viewer as a page of media content on a television screen. In some cases, a media application may be configured to display a single page of media content that includes multiple video streams from multiple sources. For instance, the football game media application, described above, may be configured to display a page of media content that includes a primary football game displayed in high definition and three secondary football games displayed in low resolution. Furthermore, some media applications may be implemented to display multiple pages of media content: the football game application described above may be configured to display a primary football game and three secondary football games on a first page and be configured to display two different “views” of the primary football game on a second page.

Media device 102 includes computer-readable media 118 having a playback application 120 and a resource manager 122. Playback application 120 may be implemented as a media control application to enable the playback of media applications 116 and/or any other audio, video, or image media content that can be rendered (as audio or visual) or displayed for viewing, such as in the form of a page of media content 112 at or in association with media device 102. For example, playback application 120 may be implemented to enable the playback of the football game application discussed above.

In order for playback application 120 to enable the playback of media applications 116 as a page of media content 112, resources 124 are assigned to the page of media content. The resources may include television tuners, pools of memory, web pages, web tabs, or any other type of resource used to display a page of media content 112. The resources of television media device 108, for example, may include an HD tuner and six PIP tuners.

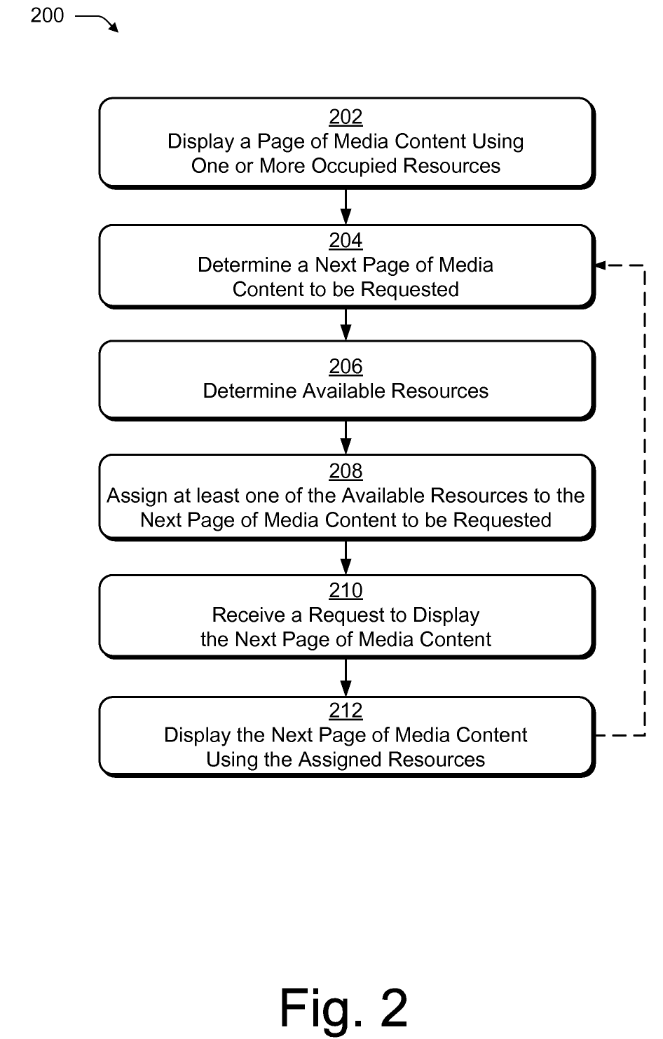

Resource manager 122 assists playback application 120 in displaying pages of media content 112 by assigning resources 124 to the page of media content. As discussed in more detail with regard to FIG. 2, resource manager 122 may enable media device 102 to assign available or unused resources to a page of media content 112 prior to receiving a request to display the page of media content.

Media device 102 is illustrated as executing playback application 120 and resource manager 122 on processors 114. These processors are not limited by the material from which they are formed or the processing mechanisms employed therein. For example, processors 114 may comprise semiconductors and/or transistors (e.g., electronic circuits (ICs)). In such a context, processor-executable instructions may be electronically-executable instructions. Additionally, computer-readable media 118 may include a wide variety of types and combinations of memory, such as random access memory (RAM), hard disk memory, removable medium memory, and other types of computer-readable storage media.

Note also that one or more of the entities in FIG. 1 may be further divided, combined, and so on. Thus, environment 100 of FIG. 1 is illustrative of one of a plurality of different environments that may employ the described techniques.

Generally, any of the functions described herein can be implemented using software, firmware, hardware (e.g., fixed-logic circuitry), manual processing, or a combination of these implementations. The term “tool,” as used herein generally represent software, firmware, hardware, whole devices or networks, or a combination thereof. In the case of a software implementation, for instance, tools may represent program code that performs specified tasks when executed on a processor (e.g., CPU or CPUs). The program code can be stored in one or more computer-readable memory devices, such as computer-readable media 118. The features and techniques of the tools are platform-independent, meaning that they may be implemented on a variety of commercial computing platforms having a variety of processors.

Example Procedure to Assign Available Resources

The following discussion describes ways in which the tools may operate to enable a media device to assign available resources to media content prior to receiving a request to display the media content. Aspects of this procedure may be implemented in hardware, firmware, or software, or a combination thereof. The procedure is shown as a set of blocks that specify operations performed by the tools, such as though one or more modules or devices and are not necessarily limited to the orders shown for performing the operations by the respective blocks. In portions of the following discussion, reference may be made to environment 100 of FIG. 1.

FIG. 2 depicts a procedure 200 in an example implementation in which the tools enable a media device to assign available or unused resources to a page of media content prior to receiving a request to display the page of media content. An example television media device that includes television tuners to display pages of media content is described as part of this example procedure, however, other media devices, which may include other resources, are also contemplated.

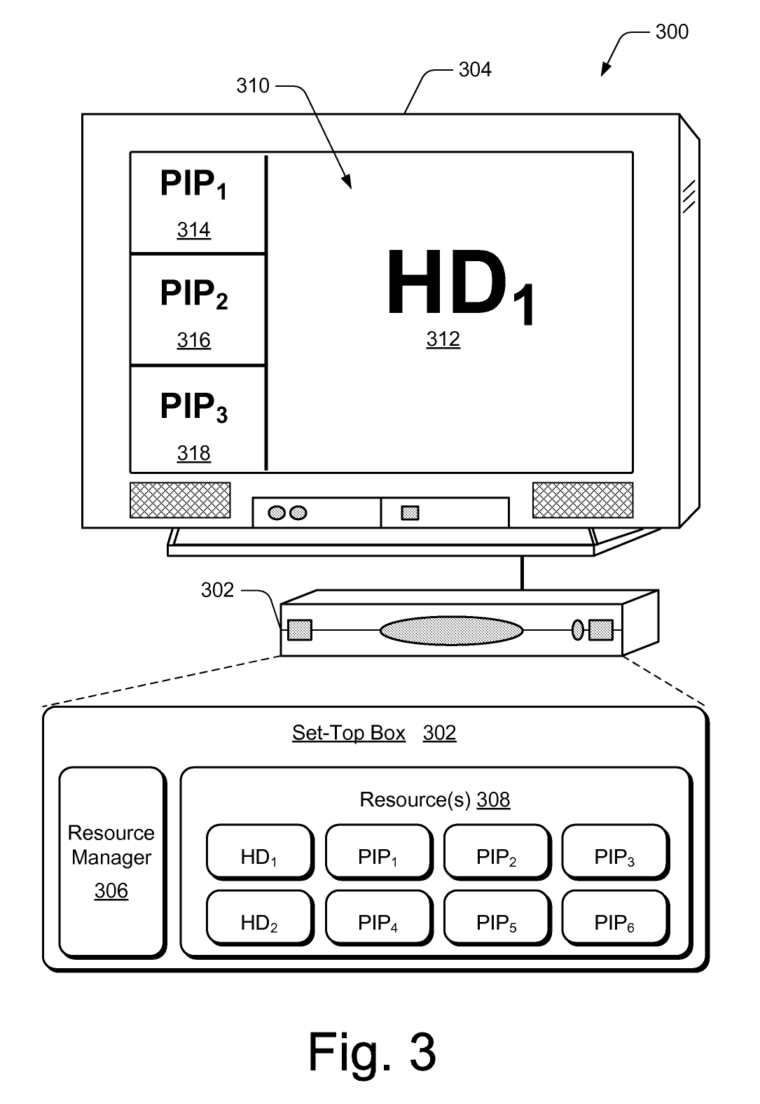

Block 202 displays a page of media content on a display of a media device using one or more occupied resources. By way of example, consider FIG. 3 which illustrates a television media device 300 including a set-top box 302 coupled to an HD television 304. Set-top box 302 includes a resource manager 306 that can assign resources 308 to a page of media content 310 displayed on the HD television. The Resources 308, in this example, include two HD tuners (HD₁, HD₂) and six PIP tuners (PIP₁, PIP₂, PIP₃, PIP₄, PIP₅, and PIP₆).

In this example, resource manager 306 has assigned occupied resources HD₁, PIP₁, PIP₂, and PIP₃ to the page of media content 310 displayed on the HD television 304. Notice that the page of media content 310 includes four different windows or sections that have each been assigned a tuner. For instance, the tuners HD₁, PIP₁, PIP₂, and PIP₃ are assigned to the page of media content at sections 312, 314, 316, and 318, respectively. The page of media content 310, by way of example, can be a page of media content associated with a football game application that includes a primary football game displayed in HD at 312 and three secondary football games displayed in low resolution at 314, 316, and 318. A football game application may present live or recorded sporting events, in this example four live football games. This application is given as an example of one that handles multiple football games, but other applications may handle various types of programs or combinations of programs, such as a single application that handles a football game, a comedy, and still images.

Block 204 determines a next page of media content to be requested. For example, in FIG. 3 resource manager 306 may determine that a user of television media device 300 may request to watch a baseball game application after watching the football game application. There are a variety of ways contemplated by which resource manager 306 may determine a next page of media content to be requested.

In some cases a next page of media content to be requested may be the last page of media content displayed by the media device. Resource manager 306 may determine that a user is switching back and forth between a football game application and a baseball game application, for example. The resource manager may then determine that because the user is currently watching a page of media content associated with the football game application, that the next page of media content to be requested will be associated with the baseball game application.

In other cases, the resource manager is provided with other information by a user of the media device that the resource manager may analyze to determine a next page of media content to be requested. While watching a football game application, for example, a user may indicate to the media device a desire to watch the baseball game application, via a user interface, when the primary football game goes to a commercial break. The user may also indicate a desire to watch a specific channel every time a media application goes to a commercial break. Additionally, a user may indicate to the media device a desire to watch a specific media application every night at a specific time.

In still other instances, the resource manager may be configured to determine a next page of media content to be requested based on the viewing history of the user. The user may have a particular order of watching media applications, for example, which the resource manager 306 may use to determine a next page of media content to be requested. A user with a viewing history indicating that the user “channel surfs,” for example, may be used to assign available resources to a next-highest or next-lowest numbered channel. Similarly, a user may watch a specific show every night at a specific time. The media device may not need any further user input, therefore, to determine that the user will watch the specific show at the specific time.

The resource manager may determine that a next page of media content to be requested will be an additional page of media content associated with an application that is currently being played. For example, as discussed above, a football game application may have multiple pages of media content, such as a first page that displays a primary football game and three secondary football games, and a second page that displays two views of the primary football game. Accordingly, the resource manager may determine that a user watching the first page of the football game application will request to watch the second page of the football game application next.

Block 206 determines available resources on the media device. Available resources are resources that are available for use, such as those that are currently unoccupied or those that are occupied but are capable of being used by media (e.g., a page) in addition to the media currently using the occupied resource. In FIG. 3, for example, resource manager 306 can determine that set-top box 302 is currently using occupied resources HD₁, PIP₁, PIP₂, and PIP₃ to display the page of media content on HD television 304. Resource manager 306 can then determine that resources HD₂, PIP₄, PIP₅, and PIP₆ are available.

Block 208 assigns at least one of the available resources to the next page of media content to be requested. For example, in FIG. 3, resource manager 306 can tune at least one of the available tuners (HD₂, PIP₄, PIP₅, and PIP₆) to the next page of media content to be requested, which was determined at block 204. Consider, for example, that resource manager 306 determines that the next page of media content to be requested is a page of media content associated with a baseball game application that includes a primary baseball game displayed in HD and three secondary baseball games displayed in low resolution. The resource manager can then tune HD₂ to a channel carrying the primary high definition baseball game and can tune PIP₄, PIP₅, and PIP₆ to the channels carrying the three secondary low-resolution baseball games.

Block 210 receives a request to display the next page of media content. This request may be received from a variety of different sources. In some cases the request can be received from a media application. A football game media application, for example, may be configured to automatically send a request to display a second page of media content associated with the football game application. The football game application may transition to a page of media content that displays one of the three secondary football games when the primary football game goes to a commercial break. In other cases, the request can be received from a user, such as via a remote control, to switch to another page of media content.

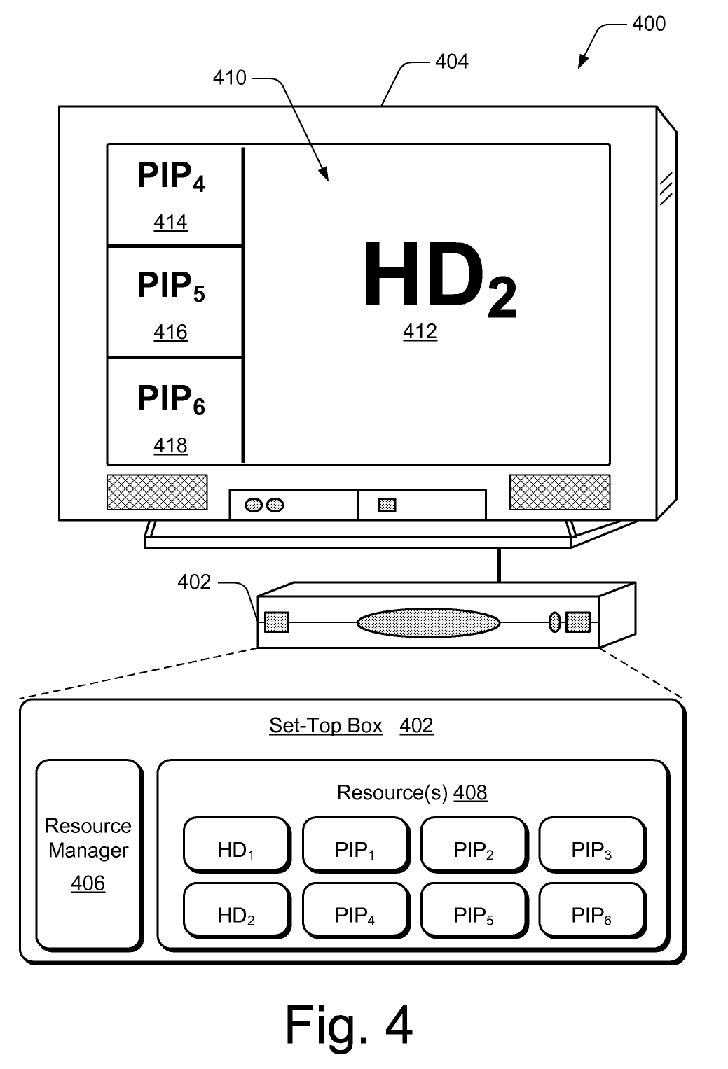

Block 212 displays the next page of media content using the resources assigned to the next page of media content at block 208. Consider FIG. 4 where a next page of media content 410 is displayed on the HD television 404 using the available resources in FIG. 3 (HD₂, PIP₄, PIP₅, and PIP₆) at 412, 414, 416, and 418, respectively. The next page of media content to be displayed can be a page of media content associated with a baseball game application that includes a primary baseball game displayed in HD and three secondary baseball games displayed in low resolution.

Note that block 212 displays a page of media content using resources that were previously assigned to the page of media content at block 208. As such, when a request is received at block 210, there may be no need to reassign resources, or, as discussed in the examples above, there may be no need to retune tuners. Furthermore, since resources have already been assigned to the next page of media content, there may not be a delay caused by reassigning resources or retuning tuners. Instead, a smooth transition without delays may occur when transitioning to and displaying the next page of media content at block 212.

In addition, because the overhead associated with reassigning resources when a request is received has been reduced or eliminated, media devices may be implemented to provide an improved visual experience when transitioning between displaying pages of media content. For example, media devices may be configured to provide a transition effect when transitioning between displaying pages of media content, such as by fading or dissolving the pages into each other.

The tools may perform blocks 204, 206, 208, 210, and 212 again and again effective to enable the media device to continuously assign available or unused resources to a next page of media content prior to receiving a request to display the next page of media content. This is shown with a dashed line from block 212 to block 204. Consider, for example, that in FIG. 4 the resources HD₁, PIP₁, PIP₂, and PIP₃ may now be available because the resources HD₂, PIP₄, PIP₅, and PIP₆ are currently being used by the page of media content 410.

Procedure 200 has been described above using an example television media device that includes television tuners to display pages of media content. It is to be appreciated, however, that various other media devices that use various other resources to carry out the procedure of blocks 202-212 are also contemplated. For example, the media device of procedure 200 may be configured as any television media device, mobile communication device, portable computer device, portable media device, computer device, gaming system, appliance device, electronic device, and/or as any other type of device capable of rendering media. Also for example, the resources of procedure 200 may include tuners, pools of memory, web pages, web tabs, and/or any other type of resource used to display media content.

Consider, for example, an example computer device that can be implemented to carry out procedure 200. In this example, the computer device may be configured to display a page of media content on one or more tabbed web-browser pages. A user of the computer device may wish to switch between tabbed web-browser pages to view pages of media content. For example, a first tabbed web page may display a football game application, as discussed above, whereas a second tabbed web page may display a baseball game application.

In order to display the pages of media content the computer device may assign resources to each page of media content. These resources, for example, may include pools of memory. Accordingly, a resource manager executing on the computer device may determine a next tabbed web page to be requested and determine available resources, such as available memory. The resource manager may then assign the available resources, such as memory, to the determined next tabbed web page prior to receiving a request to display a page of media content on the next tabbed web page.

Accordingly, when the user requests to transition from the tabbed web page displaying the football game application to the tabbed web page displaying the baseball game application, resources will already have been assigned to the baseball game application. The computer device, therefore, will not need to assign or reassign resources, such as memory, to the tabbed web page displaying the baseball game application. As such, the transition between web pages will be smooth with fewer or no appreciable delays.

### Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed inventions.

1. A method comprising:
displaying a current page of media content on a display of a media device using one or more occupied resources;
determining a next page of media content to be requested prior to receiving a request to display the next page of media content;
assigning one or more available resources to the next page of media content prior to receiving the request to display the next page of media content, the available resources comprising resources that are not the one or more occupied resources being used to display the current page of media content; and
responsive to receiving a request to display the next page of media content, displaying the next page of media content on the display of the media device using the assigned resources.

2. The method of claim 1, further comprising displaying a transition effect on the display of the media device prior to displaying the next page of media content, the transition effect based at least in part on the next page of media content.

3. The method of claim 1, wherein the occupied resources comprise one or more currently used television tuners and the available resources comprise one or more not currently used television tuners.

4. The method of claim 1, wherein the current page of media content includes a current video stream and the next page of media content includes a next video stream different from the current video stream.

5. The method of claim 1, wherein the act of determining the next page of media content to be requested comprises analyzing information received via a user interface of the media device.

6. The method of claim 1, wherein the act of determining the next page of media content to be requested comprises analyzing a viewing history of a user of the media device.

7. The method of claim 1, wherein the act of displaying the current page of media content displays the current page of media content in a first tabbed web page of a web browser and wherein the act of displaying the next page of media content displays the next page of media content in a second tabbed web page of the web browser.

8. One or more computer-readable storage media having computer-readable instructions therein, that when executed by a media device, cause the device to perform acts comprising:
determining a next page of media content to be requested; and
assigning available resources to the next page of media content to be requested prior to receiving a request to display the next page of media content.

9. The computer-readable storage media of claim 8, further comprising, responsive to receiving a request to display the next page of media content, displaying the next page of media content on a display of the media device using the assigned resources.

10. The computer-readable storage media of claim 8, further comprising displaying a transition effect on a display of the media device responsive to receiving the request to display the next page of media content.

11. The computer-readable storage media of claim 8, wherein the available resources comprise television tuners.

12. The computer-readable storage media of claim 8, wherein the act of determining the next page of media content to be requested comprises analyzing information received via a user interface of the media device.

13. The computer-readable storage media of claim 8, wherein the act of determining the next page of media content to be requested comprises analyzing a viewing history of a user of the media device.

14. The computer-readable storage media of claim 8, wherein at least one of the available resources comprises a high-definition (HD) tuner.

15. A method comprising:
displaying a current page of media content on a display of a television media device using one or more occupied television tuners tuned to one or more television channels;
determining a next page of media content to be requested, the next page of media content configured to display one or more additional television channels;
tuning one or more available television tuners to the one or more additional television channels, the one or more available television tuners comprising television tuners that are not the one or more occupied television tuners; and
responsive to receiving a request to display the next page of media content, displaying the next page of media content on the display of the television media device using the one or more available television tuners.

16. The method of claim 15, further comprising fading the next page of media content into the current page of media content on the display of the television media device prior to displaying the next page of media content.

17. The method of claim 15, wherein at least one of the one or more available television tuners comprises a picture-in-picture (PIP) tuner.

18. The method of claim 15, wherein the one or more additional television channels comprises multiple additional television channels and the next page of media content includes a video stream from each of the multiple television channels.

19. The method of claim 15, wherein the act of determining the next page of media content to be requested comprises analyzing information received via a remote control of the television media device.

20. The method of claim 15, wherein the act of determining the next page of media content to be requested comprises analyzing a television viewing history of a user of the television media device.
